(19) United States
(12) Patent Application Publication
(10) Pub. No.: US 2010/0304587 A1
(43) Pub. Date: Dec. 2, 2010

(54) CONNECTOR COVER

(76) Inventor: Makoto Fukushi, Kanagawa (JP)

Correspondence Address: 3M INNOVATIVE PROPERTIES COMPANY, PO BOX 33427, ST. PAUL, MN, 55133-3427, US

(21) Appl. No.: 12/864,616

(22) PCT Filed: Jan. 19, 2009
(86) PCT No.: PCT/US09/31372

§ 371 Date: Jul. 26, 2010

(30) Foreign Application Priority Data
Jan. 31, 2008 (JP) 2008-020763

(51) Int. Cl. H01R 13/44

(52) U.S. Cl. 439/136

(57) ABSTRACT

To provide a connector cover that has dust preventing functions when the connector is not connected, and prevents inadvertent disengagement when a connector is connected. Provide a connector cover, comprising: a plate covering a receptacle open end; and an arm protruding from said plate; wherein the thickness of the arm is thinner than a gap between the latch lever of the plug and the body, when the plug is inserted into the open end.

### TECHNICAL FIELD

The present invention relates to a cover that covers the open end of a connector.

### BACKGROUND

The exposed end part of a fiber optic connector or an electrical connector preferably has a cover that covers the end in order to prevent contamination by dust and the like. Various types of covers can be used as this connector cover. The connector cover may have other functions in addition to covering the exposed end to prevent contamination.

Specifically, Japanese Unexamined Patent Application H7-263070 describes a “connector dust cover with protrusions to prevent loss of the elasticity of a connector locking lever.” Furthermore, U.S. Pat. No. 5,030,120 describes a “dust cover that prevents a plug connector from longitudinally detaching from the receptacle connector by frictional engagement between the sealing surface of the cover member and the coupling nut of the plug connector.”

The connector cover covers the exposed end of a connector until the connector is mated with another connector, and has a function of protecting from dust, but once the connectors have been mated, the exposed end will be blocked, and the function of protecting from dust will not be necessary. The unused connector cover can easily be lost, or if integrally provided on the connector, will not easily be lost, but maybe get in the way when using that connector or another connector. On the other hand, the mated connector may be disengaged by an inadvertent action, thus making the electrical or optical characteristics instable.

### SUMMARY

The present invention provides a connector cover that has dust preventing functions when the connector is not connected, and prevents inadvertent disengagement when the connector is connected.

In one embodiment, the present invention provides a connector cover, comprising a plate covering a receptacle open end and an arm protruding from said plate; wherein when a plug is inserted into said opening, the thickness of said arm is less than the gap between a latch lever and a body of said plug.

In another embodiment, the present invention provides a connector cover, comprising a plate covering a receptacle open end and an arm protruding from said plate; wherein said arm is inserted between the body of the plug that is inserted into said open end and the latch lever of the plug, and displacement of said latch lever is controlled.

### BRIEF DESCRIPTION OF THE DRAWINGS

FIG. 1 is a perspective view showing a connector with a cover, according to the first embodiment of the present invention.

FIG. 2 is a perspective view of the connector of FIG. 1 in the condition where the cover is closed.

FIG. 3 is a perspective view showing the mated condition of the receptacle and plug.

FIG. 4 is a perspective view of the connector of FIG. 3, as seen from an angle from the bottom.

### DETAILED DESCRIPTION

In the first embodiment of the present invention, a connector cover that can cover the open end of a receptacle can prevent inadvertent detachment of a mating plug, and can restrict the displacement of the latch lever of the plug that is engaged in the receptacle.

The connector cover according to the present invention can cover the open end of a connector when the connector is not engaged in order to prevent dust contamination, and when the connector is mated to another connector, the displacement of the latch lever of the mated connector is restricted by an arm of the connector cover to prevent inadvertent disengagement. The connector used with this connector cover is generally referred to as a receptacle or a socket, and is a female type connector that receives an opposing mating connector in the mating end. This connector is provided beforehand on wiring boards and devices or the like in order to achieve an electrical or optical connection if necessary by inserting an opposing mating connector into the open end. Therefore, until connected with the opposing mating connector, the cover covers the open end in order to prevent dust and damage to the open end.

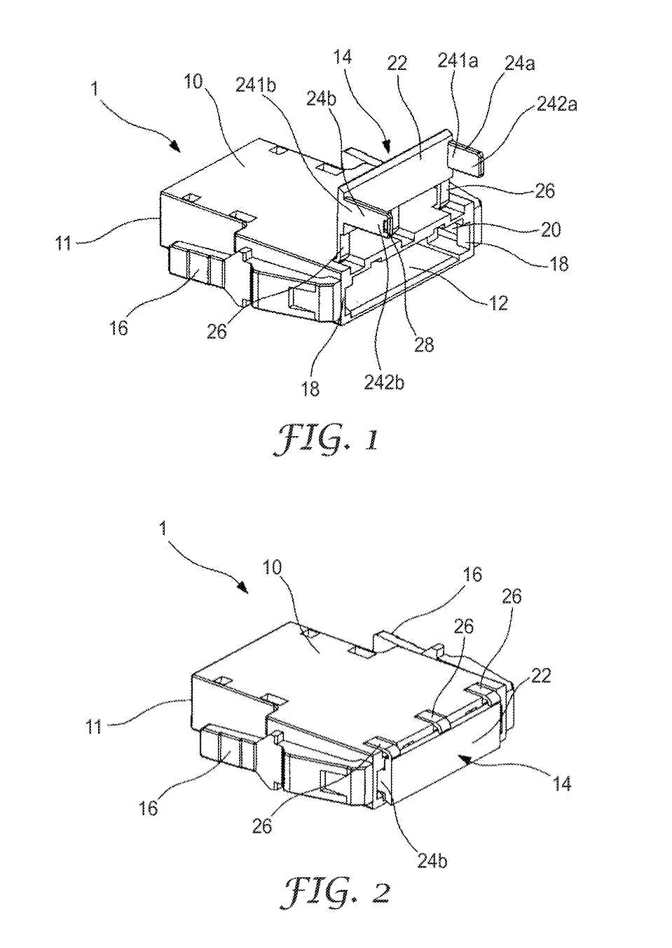

The connector cover of the present invention will be described below while referring to the drawings. FIG. 1 is a perspective view showing an electrical connector 1 with a connector cover according to the first embodiment of the present invention. FIG. 2 is a perspective view showing the condition where the connector cover is closed for the connector shown in FIG. 1. This connector 1 is a connector known as a receptacle connector, and receives a connector 2 (discussed later) known as a plug connector into the housing.

The receptacle 1 comprises a housing 10 and a cable mounting part 11. The housing 10 has essentially a rectangular solid shape, has an open end 12 on the front end in the direction of mating, and has a cover 14 above the open end 12. The housing 10 further includes a latch arm 16 on both sides of the open end for securing the receptacle 1 to a wiring board or the like. The housing 10 can be formed from any material, such as any type of plastic or metal material. The open end 12 is an open portion (cavity portion) with a size that can receive the opposing mating connector 2, and can internally contain one or a plurality of contacts therein (not shown in the drawings). The cable mounting part 11 is a section that mechanically and electrically connects the cable and the contacts, and the cable is inserted into a cable hole of the cable mounting part 11. Mounting the cable can be performed by a variety of commonly known methods, such as a method of insulation displacement, which connects a cable to essentially a U-shaped contact, or by soldering, or the like. Locking holes 20 that engage with the plug 2 are formed on both side walls 18 of the open end 12.

The cover 14 comprises a plate 22, arms 24a, 24b, and a plurality of hinges 26. The plate 22 is essentially a rectangular plate shaped member, and has a size and shape that generally covers the open end 12. The arms 24a, 24b extend essentially perpendicular from the surface of the plate 22 that covers the open end 12 in proximity to both ends of the plate 22.

The hinge 26 is a flexible section that allows the cover 14 to move between a closed position (refer to FIG. 2) that covers the open end 12 and a displacement preventing position (refer to FIG. 3) which will be described later. The length of the hinge 26 is set to a length that allows the cover 14 to cover the open end 12 and to be positioned in a displacement preventing position. In the process of covering the open end 12 with the cover 14, the hinge 26 bends and allows rotational movement of the cover 14. When the cover 14 is in the closed position, the arms 24a, 24b are inserted into the open end 12. These arms 24a, 24b contact with the inside wall of the open end 12, and prevent the cover 14 from being inadvertently detached from covering the open end 12 using frictional forces. In order to more positively attach the cover 14, slots (not shown in the drawings) can be provided on the inside of the open end 12 for at least one of the arms 24a, 24b to be inserted. The arm that is inserted into the slot is interpositioned between the inside walls of the slot. A protrusion 28 can also be formed on the surface of either the inside or the outside of each arm 24a, 24b. These protrusions 28 deform slightly when the arm is inserted into the slot, and thereby the cover 14 is more securely attached in the closed position.

The illustrated embodiment is a construction where only one arm 24b is inserted into a slot. In order for the arm 24b to reach the slot, the arm 24b is made longer than the other arm 24a, but slots can also be formed corresponding to both of the arms 24a, 24b. It is also possible to make both arms 24a, 24b equal length.

As another embodiment, a locking part which can engage with the protrusions 28 of the arms 24a, 24b can be formed on the inside of the open end 12 in addition to or instead of forming a slot. In this case as well, it is acceptable if only one arm engages with the locking part, but it is also acceptable for both arms to engage with the locking parts.

In the illustrated embodiment, the arms are provided in proximity to both the ends of the plate, but providing the arms in proximity to only one of the ends is also acceptable. Furthermore, the position of the arms is not restricted to being in proximity to the ends in the longitudinal direction of the plate, and the arms can also be located in any arbitrary location that matches the shape of the plug 2.

The cover 14 may be formed as a separate component from the housing 10, and can be attached to the housing by any arbitrary method. Cost advantages can be achieved by integrally forming the housing 10 and the cover 14, but greater degrees of freedom for material selection and design can be achieved by forming separate components.

The receptacle 1 of the present embodiment is typically used with a wiring board. The receptacle 1 is inserted into an opening formed on a plate of the wiring board. Note, the receptacle 1 can be attached using a variety of commonly known methods other than a latch arm 16, such as by fastening with screws.

FIG. 3 and FIG. 4 are perspective views showing the condition where the receptacle 1 and the plug 2 are mated. The plug 2 comprises a body 40, a cable mounting part 41, and a latch lever 42. The body 40 also has contacts which are not shown in the drawings. The latch lever 42 extends in mating direction from both side walls near the back end of the body 40. A locking part (not shown in the drawings) that engages with a locking hole 20 in the receptacle 1 is provided on the outside surface of the latch lever 42 at the tip end. A contact is electrically connected to a contact on the receptacle 1 side when the plug 2 is mated to the receptacle 1, and is mechanically and electrically connected to a cable which is inserted into cable hole 41a of the cable mounting part 41.

After the plug 2 has been inserted into the receptacle 1, the cover 14 of the receptacle 1 covers the plug 2, and thereby the cover 14 is located in the displacement preventing position. In the displacement preventing position, the plate 22 is essentially parallel with the top surface of the body 40 of the plug 2. The interval between the arms 24a, 24b is set to be essentially equal to the width of the body 40 of the plug 2, and the thickness of the arms is set to be about the same or narrower than the gap between the body 40 and the latch lever 42 in the mated condition. Therefore, when the cover 14 covers the plug 2, both arms 24a, 24b are inserted between the body 40 of the plug 2 and the latch lever 42. The thickness of the arms 24a, 24b is a thickness which will not allow displacement of the latch lever 42, or a thickness that will only allow the latch lever 42 to move to the degree that a locking tab, not shown in the drawings, on the latch lever 42 will not become unlocked from the locking hole 20 of the receptacle. Therefore, when the cover 14 is located in the displacement preventing position, even if the latch lever 42 of the plug 2 is inadvertently operated, the condition of mating between the plug 2 and the receptacle 1 will be prevented from partially disengaging and an electrically unstable connection will be prevented. Furthermore, the plate 22 will be essentially parallel with the top surface of the body 40, and therefore even when the cover 14 is in the displacement preventing position, the increase in the thickness of the connector can be kept to a minimum.

With the illustrated embodiment, the length of the arm and the position of the protrusion 28 are set such that the protrusion 28 will protrude beyond the bottom surface 46 of the latch lever 42 when the cover 14 is arranged from the top surface 44 side of the latch lever to the displacement preventing position. Therefore, the protrusion 28 will latch onto the bottom surface 46 of the latch lever 42, and the cover 14 will effectively be prevented from inadvertently being detached from the displacement preventing position. In another embodiment, a protruding tab or a recess is formed in the surface of the latch lever 42 facing the body 40, and the same effect can be achieved by locking these with the protrusion 28. In yet another embodiment, the protrusion 28 is located on the inside surface (surface facing the other arm) of the arms 24a, 24b, and the protrusion 28 can therefore lock onto the body 40. Furthermore, in order to make the locking condition more secure, the arms 24a, 24b can be set at an incline with regards to the direction perpendicular to the plate 22 such that the interval between arms 24a, 24b is narrower at their tips 242a, 242b than at their bases 241a, 241b. In this manner, the arms 24a, 24b are elastically pressed onto the latch lever 42, and the locking force between the latch lever 42 and the arms 24a, 24b can be increased. In case the arms lock onto the body 40, the arms 24a, 24b can be set at an incline with regards to the direction perpendicular to the plate 22 such that interval between arms 24a, 24b is broader at their tips 242a, 242b than at their bases 241a, 241b.

With the illustrated embodiment, the latch lever 42 is extended in the mating direction, in proximity to the back end of the plug 2, but the latch lever can also extend opposite the mating direction, in proximity to the front end of the plug 2. Furthermore, the latch lever 42 can be located on the top or bottom of the plug 2, and having only one latch lever is also acceptable.

With the aforementioned embodiments, the case of a connector for an electrical connection was described, but the present invention is not restricted only to connectors for electrical connections, and can also be applied to other connectors such as optical fiber connectors. Furthermore, in this case, a so called female connector was shown as a receptacle, but the present invention can be applied to couplings where two plug type connectors are aligned and joined, and in this specification, a receptacle is interpreted as also including the coupling.

1. A connector cover comprising:
a plate covering a receptacle open end; and
an arm protruding from said plate;
wherein when a plug is inserted into said open end, the thickness of said arm is less that of the gap between a latch lever and a body of said plug.

2. A connector cover comprising:
a plate covering a receptacle open end; and
an arm protruding from said plate;
wherein said arm is inserted between the body and the latch lever of a plug that is inserted into said open end, and displacement of said latch lever is restricted.

3. The connector cover according to claim 1 or 2, wherein a protrusion is further formed on the surface of said arm.

4. The connector cover according to claim 3, wherein an arm is provided in proximity to both ends on each side of said plate.

5. The connector cover according to claim 4, wherein the distance between said arms is essentially equal to the width of said plug.

6. The connector cover according to claim 5, wherein said receptacle and said plug are mated together, and when said cover is in a displacement preventing position, the protrusions located on the surface of said arm will lock into said plug.

7. The connector cover according to claim 5, further comprising a hinge, wherein the receptacle and the housing are integrally formed.
